(19) United States
(12) Patent Application Publication
(10) Pub. No.: US 2004/0252950 A1
(43) Pub. Date: Dec. 16, 2004

(54) Method for producing an assembly comprising a waveguide section and an optical component

(75) Inventors: Otto Schempp, Bab Rappenau (DE); Mathias Gerner, Untereisesheim (DE)

Correspondence Address: Charles N. J. Ruggiero, Esq., Ohlandt, Greeley, Ruggiero & Perle, LLP, 10th Floor, One Landmark Square, Stamford, CT, 06901-2682, US

(73) Assignee: Molex Incorporated

(21) Appl. No.: 10/833,941

(22) Filed: Apr. 28, 2004

(30) Foreign Application Priority Data
May 9, 2003 (DE) 103 21 137.3

(51) Int. Cl. G02B 6/36

(52) U.S. Cl. 385/88; 385/85

(57) ABSTRACT

A simple, effective and inexpensive method produces an optical connection on an optical component. A waveguide section, a sleeve for enclosing the waveguide section and an optical component, which has a receptacle for the waveguide section and the sleeve, are provided. The waveguide section is inserted with the first end face into the receptacle of the component and is only cut to length after insertion, while it is mounted on the component. The front end face of the waveguide section is milled away in a centered, spherical concave form.

### FIELD OF THE INVENTION

The invention relates to a method for producing an arrangement comprising a waveguide section and an optical component in general and for producing an optical connection on an optical component in particular.

### BACKGROUND OF THE INVENTION

Optical data transmission is increasingly gaining in significance over electrical data transmission. Therefore, intensive work is in progress on new connecting techniques and standards for optical connectors.

However, the production of optical connections faces considerably greater difficulties from various aspects than electrical connections. In particular, optical connecting points require small production tolerances.

An important area of application for optical data transmission is the automotive sector. Work is in progress there on a common standard, the “Media Oriented Systems Transport” (MOST®) to standardize the networking of multimedia applications in automobiles.

To connect an optical waveguide to an optoelectronic circuit in an optical component, the component is typically provided with a short waveguide section, which is fastened on the component and forms a connecting link between the circuit and the waveguide.

However, to establish a reliable connection, precise dimensioning tolerances have to be maintained. In particular, the distance of the connection face from a sleeve surrounding the waveguide section and the distance from the component housing are of decisive significance, for example for the loss at the interface between the waveguide and waveguide section.

According to a known method, the waveguide section is firstly brought to a precise length and subsequently inserted into the sleeve or adhesively fixed on the component.

One problem with this procedure is that the optical connection face in the component is poorly toleranced and therefore the length of the waveguide section has to be created very precisely. This makes production and machining complex and cost-intensive. Furthermore, the longitudinal positioning of the connection face of the waveguide section is difficult.

### GENERAL DESCRIPTION OF THE INVENTION

It is therefore an object of the invention to provide a method for producing an arrangement comprising a waveguide section and an optical component which works in a simple, effective and inexpensive manner.

A further object of the invention is to provide a method for producing an arrangement comprising a waveguide section and an optical component which maintains predetermined tolerances precisely and reliably and permits a permanent reliable optical connection on the waveguide section.

Yet another object of the invention is to provide a method for producing an arrangement comprising a waveguide section and a component which avoids or at least reduces the disadvantages of the prior art.

The object of the invention is already achieved in a surprisingly simple way by the subject-matter of the independent claims. Advantageous developments of the invention are defined in the subclaims.

The invention proposes a method for producing an assembly comprising an optical waveguide or waveguide section and an optical or electrooptical component, in which the waveguide section is fastened on the component as an optical connection or terminal. The waveguide section preferably comprises a core and a jacket surrounding the core, and has in this case a first and a second end face, respectively for coupling optical signals in and out, the second end face lying opposite from the first end face. The component, or preferably a housing of the component, has a receptacle into which the optical waveguide is inserted with the first end face, in order to permit optical contact with optical circuits in the component, so that signals can be coupled into the component and/or can be coupled out of the component via the first or rear end face.

The optical waveguide section is preferably relatively short, for example in the range of several tens of millimeters, and has the function of a connecting link between the component and a fiber-optic cable, by means of which the component can in turn be connected to other components for optical signal transmission.

The waveguide section is enclosed in a sleeve which is, in particular, substantially cylindrical or in an annular holder, known as a ferrule, the enclosure preferably being carried out before the fastening on the component, and this sleeve being fastened on the housing of the component. The sleeve and the waveguide section consequently form a connection pin for connecting a fiber-optic cable or its optical connector.

It is particularly advantageous within the scope of the method according to the invention firstly to provide a long waveguide with a sleeve, for example to encapsulate it with a plastic sleeve coming from a reel, and subsequently divide it up, for example cut it up, into short pieces, in order to obtain the waveguide sections. The waveguide section can consequently be inserted into the sleeve such that it is flush or even with an overhang.

In an advantageous way, approximate cutting to length of the connection pin or composite element comprising the waveguide and the sleeve is sufficient at this stage of the method. This is so because, according to the invention, the approximately cut-to-length connection pin is fastened, for example adhesively attached or welded, on the housing of the optical component and only subsequently subjected to finishing work or cut to length in order to obtain the final and precise length.

The final cutting-to-length of the waveguide section consequently only takes place after the insertion of the waveguide section and the sleeve into the receptacle of the component, i.e. when the latter have together been mounted or fastened on the component and the waveguide section is surrounded by the sleeve.

During the final cutting to a predetermined length, that is after the mounting of the connection pin and the sleeve on the component or in the mounted state, a precisely predefined positioning of the second end face of the waveguide section is achieved in relation to an end face of the sleeve, or its front edge, surrounding said second end face and/or in relation to the component or its housing. In this respect, a tolerance of less than 50 μm, in particular less than 10 μm, is achieved.

As an alternative, it is also possible that firstly the sleeve is fastened on the component and after that the waveguide section is inserted into the sleeve. It is also possible for the component housing and the sleeve to be of a one-piece or integral configuration.

One advantage of the method according to the invention is that it is considerably easier to bring the waveguide section to the final precise length when it is on the ready mounted component and/or inserted in the sleeve than it is to accomplish this before mounting.

The cutting-to-length of the waveguide section preferably takes place by means of machining the second or front end face of the waveguide section, that is the end face remote from the component. The front end face is preferably machined by material removal or abrasion, in particular milled or ground away by means of a milling or grinding tool.

A diamond tool is preferably used for this purpose. This has the advantage that, in a single working step, both the length of the waveguide section is exactly defined and the surface of the front end face is already machined with a finish suitable for coupling optical signals in and/or out. There is consequently no need for an additional polishing step.

In other words, the machining of the surface of the front end face and its exact longitudinal positioning in relation to the sleeve or the component, or the definition of the length of the waveguide section, takes place simultaneously and/or in one working step.

According to a preferred embodiment of the invention, when it is cut to length, the waveguide section is shortened in such a way that a predetermined depression or a predetermined set-back of the front end face of the waveguide section is created in relation to an end face of the sleeve at the front or enclosing the front end face of the waveguide section. In this case, a predetermined distance is also created between the front end face of the waveguide section and the component is or its housing.

The set-back of the front end face of the waveguide section in relation to a front edge of the sleeve is preferably between 0 μm and 500 μm, preferably 0 μm to 50 μm, most preferably in the range from 15 μm to 30 μm. It is consequently possible in an advantageous way to comply with the MOST specifications. In particular, the minimum and/or maximum set-back lie within the aforementioned intervals over the entire end face of the waveguide section or the core.

The milling or grinding cutter preferably rotates transversely in relation to the longitudinal axis or longitudinal line of the waveguide section and is moved parallel onto the waveguide section in order to mill or grind away the waveguide section until the predefined set-back is created. Consequently, the set-back can be created in a simple way.

The set-back avoids direct contact of the front end face of the waveguide section with a waveguide to be connected to it, since the ferrule acts as a stop, if appropriate in interaction with a counterpiece. By keeping the two waveguides that are to be optically contacted apart, losses at the interfaces are avoided.

It may also be advantageous to machine the front end face of the sleeve, in particular remove material from it or mill or grind it away, at a point in time at which the waveguide section and the sleeve are fastened on the component and/or in one working step and/or simultaneously with the front end face of the waveguide section. As a result, the distance of the front end face of the sleeve from the component housing is also defined in this working step. The front end face of the sleeve can in this case be machined completely or in certain regions.

According to a particularly preferred embodiment of the invention, a surface of the front end face that is in particular concave in two dimensions is created by means of the machining of the front end face of the waveguide section. The concave surface preferably has in this case an apex point within the circumference of the waveguide section, in particular a centered apex point.

The concave surface is created most easily with a milling or grinding cutter with a convex surface.

To a person skilled in the art, it may appear at first glance to be illogical and disadvantageous to form the connection face of the waveguide section in a concave form, since it is known that non-planar connection faces are liable to create increased diffusion. Therefore, until now it has been endeavored for the most part to polish the surface as flat as possible.

However, the inventor has surprisingly found that the diffusion, and consequently the insertion loss, is kept within acceptable limits, in particular in the preferred areas of application of the invention, so that the advantages of the invention, that is the simplicity of the method, by far outweigh this apparent disadvantage.

Particularly preferred is an elliptical, in particular spherical, to be more precise spherical-concave, form of the surface of the front end face, which is created for example by a milling or grinding cutter with a surface which is spherical at least in certain portions.

The inventor has also found that a milling or grinding cutter with a radius or radius of curvature of 2 mm to 100 mm, preferably 4 mm to 40 mm, particularly preferably 8 mm to 22 mm, produces outstanding results. Consequently, after machining, the surface of the front end face of the waveguide section also has a radius of curvature of 2 mm to 100 mm, preferably 4 mm to 40 mm, particularly preferably 8 mm to 22 mm. The width of the blade, i.e. the portion of the tool that removes material, is preferably 0.1 mm to 10 mm, in particular 0.5 mm to 5 mm, particularly preferably 2 mm ±50%.

These dimensions have proven to be particularly suitable if, as preferred, a waveguide section made of plastic or a plastic optical fiber (POF) with a core diameter of approximately 1 mm and a jacket diameter of 1.5 mm is used.

Preferably, at least the entire surface of the front end face, if appropriate including a protective coating surrounding the fiber, is formed in a concave manner. The front end face of the sleeve may either remain completely planar or be provided at least partly or completely with a concave surface.

According to an exemplary embodiment of the invention, the front end face of the sleeve has an inner ring and an outer ring, which are adjacent or concentric in relation to each other, the inner ring being provided with a concave surface and the outer ring having or retaining a planar surface.

As an alternative to milling or grinding, the front end face may, however, also be thermally molded. For this purpose, a melt die which is, in particular, convex or spherically convex is moved under force or pressed onto the front end face of the waveguide section until a predetermined set-back is achieved. It is particularly advantageous to use a rotating melt die with a hotter portion and a colder portion. In this case, firstly the hotter portion is pressed onto the front end face to melt and mold it and the die is subsequently turned further until the front end face is cooled again by means of the colder portion. As a result, a surface of good optical quality is achieved.

Not only during the thermal molding is it preferred to use a sleeve material which has a coefficient of thermal expansion similar to that of the material of the waveguide section. The two coefficients of expansion preferably deviate from each other by at most 20%. As a result, the desired tolerances are maintained over the entire operating temperature range, for example in an automobile from −50° C. to +100° C.

The invention is explained in more detail below on the basis of exemplary embodiments and with reference to the drawings, identical and similar elements being provided with the same designations and it being possible for features of the various embodiments to be combined with one another.

### BRIEF DESCRIPTION OF THE FIGURES

In the Figures:

FIG. 1 shows a perspective view of an optoelectronic component with a connection pin,

FIG. 2 shows a schematic representation of an optical data transmission connection,

FIG. 3 shows a perspective view of a connection pin,

FIG. 4 shows a cross section through the connection pin from FIG. 3,

FIG. 5 shows a perspective view of a connection pin according to an embodiment of the invention,

FIG. 6 shows a cross section through the connection pin from FIG. 5 in the form of a detail,

FIG. 7 shows a perspective view of a connection pin according to a further embodiment of the invention,

FIG. 8 shows a cross section through the connection pin from FIG. 7 in the form of a detail,

FIG. 9 shows a perspective view of a connection pin according to a further embodiment of the invention,

FIG. 10 shows a cross section through the connection pin from FIG. 9 in the form of a detail,

FIG. 11 shows a schematic sectional drawing of a milling apparatus according to the invention,

FIG. 12 shows a front view of a milling cutter in the form of a detail and

FIG. 13 shows a side view of the milling cutter from FIG. 12.

### DETAILED DESCRIPTION OF THE INVENTION

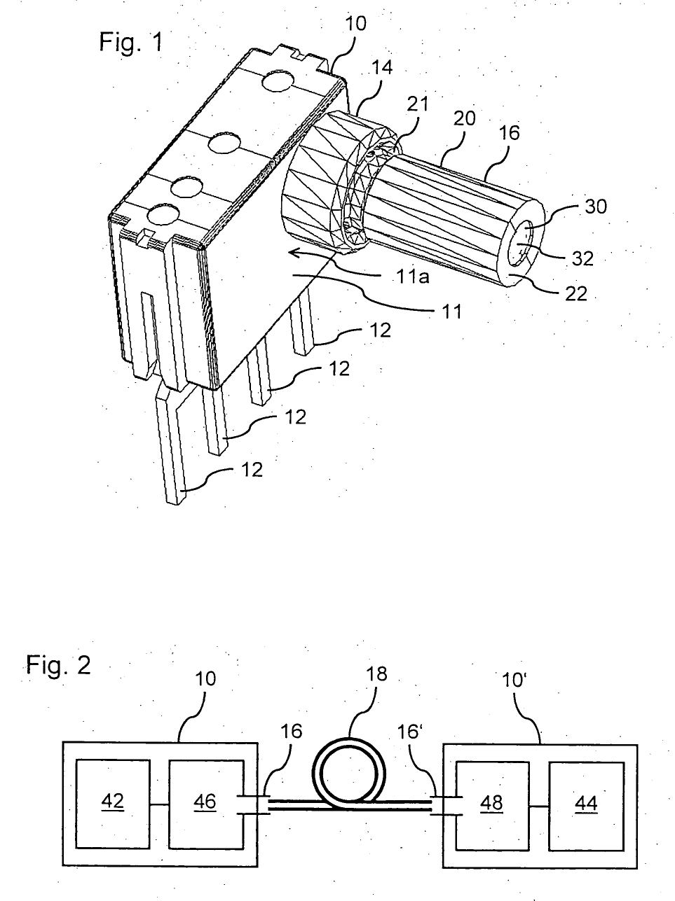

FIG. 1 shows an optoelectronic component 10 with a plurality of electrical connections 12 for making contact with a circuit carrier and with an annular receptacle 14, in which a connection pin 16 is inserted and adhesively fixed.

The component 10 has a housing 11 with a front side 11a. The optical connection pin 16 comprises a hollow-cylindrical plastic sleeve or ferrule 20 and an optical waveguide section 30, which are inserted in the receptacle 14 by in each case a first or rear end face 24 and 34, respectively (see FIG. 4). The sleeve or annular holder 20 has, for instance in the rear third, or the third toward the component 10, a groove 21 for fastening a connector (not shown).

The plastic sleeve 20 has a second or front annular end face 22, which surrounds or encloses a second or front circular end face 32 of the plastic waveguide section 30. The front end face 32 of the optical waveguide section 30, which forms an optical connection face for a waveguide or a fiber-optic cable 18, is set back from the front end face 22 of the sleeve.

Referring to FIG. 2, an optoelectronic connection arrangement is represented, with a first and a second electronic component 42, 44 to be connected. Connected to the electronic components 42, 44 are optoelectronic or electrooptical components, in particular converters 46, 48, which are respectively connected by means of a connection pin 16, 16′ and the fiber-optic cable 18.

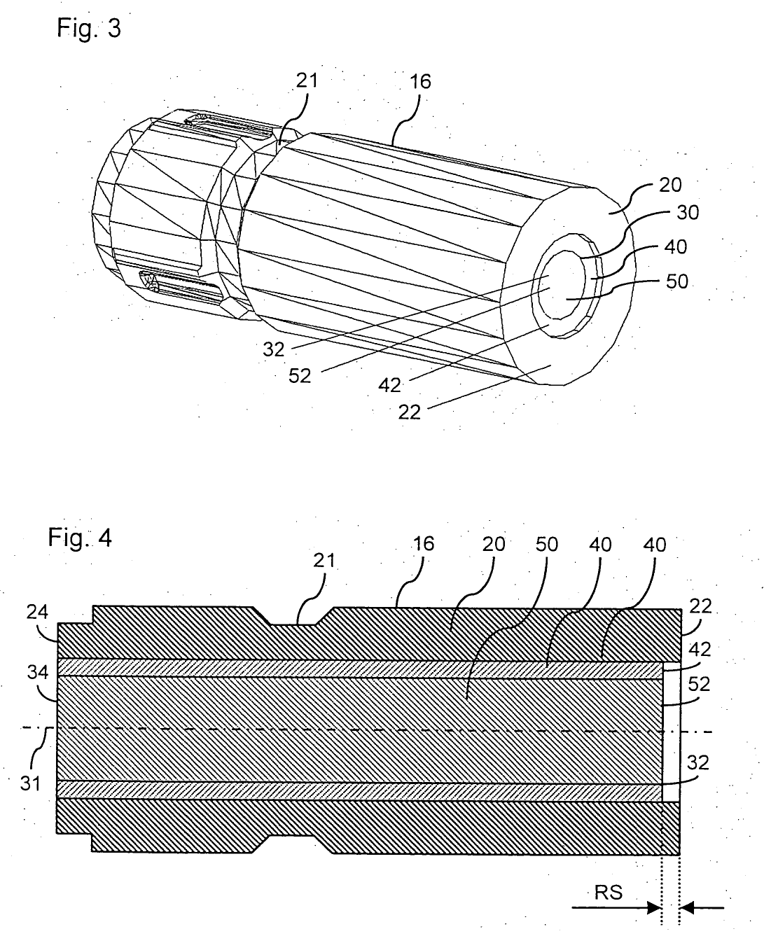

Referring to FIGS. 3 and 4, the connection pin 16 from FIG. 1 is represented. It can be seen that the waveguide section 30 comprises a core 50 and a jacket or coating 40. The plastic jacket 40 surrounds the core 50. It should be noted, that the waveguide section 30 or plastic optical fiber section further comprises a cladding (not shown separately in the Figures) surrounding the waveguiding inner core. In other words, the core 50 represents the waveguiding inner core and the cladding. The front end face 52 of the core 50 and a front end face 42 of the jacket 40 form a front end face 32 of the waveguide section 30 and are respectively arranged perpendicularly in relation to a longitudinal axis 31 of the waveguide section 32 or connection pin 16. Furthermore, in this example the front end faces 52 and 42 are arranged such that their surfaces are flush with each other and are formed in a planar manner.

The front end face 32 of the waveguide section 30 and the front end faces 42 and 52 of the jacket and core have a constant set-back RS=15 μm from the front end face 22 of the sleeve 20.

The connection pin 16, as it is represented in FIGS. 1, 3 and 4, may have been produced in a conventional way, that is to say that the waveguide section 30 was adhesively cemented into the sleeve with the finish-machined front end face. The connection pin 16 may, however, also be produced by the method according to the invention, the set-back RS of the planar front end face 32 of the waveguide section 30 being created with a cylindrical milling cutter which is moved transversely in relation to its axis of rotation over the end face 32 of the waveguide section 30 once the connection pin 16 has been mounted on the component 10.

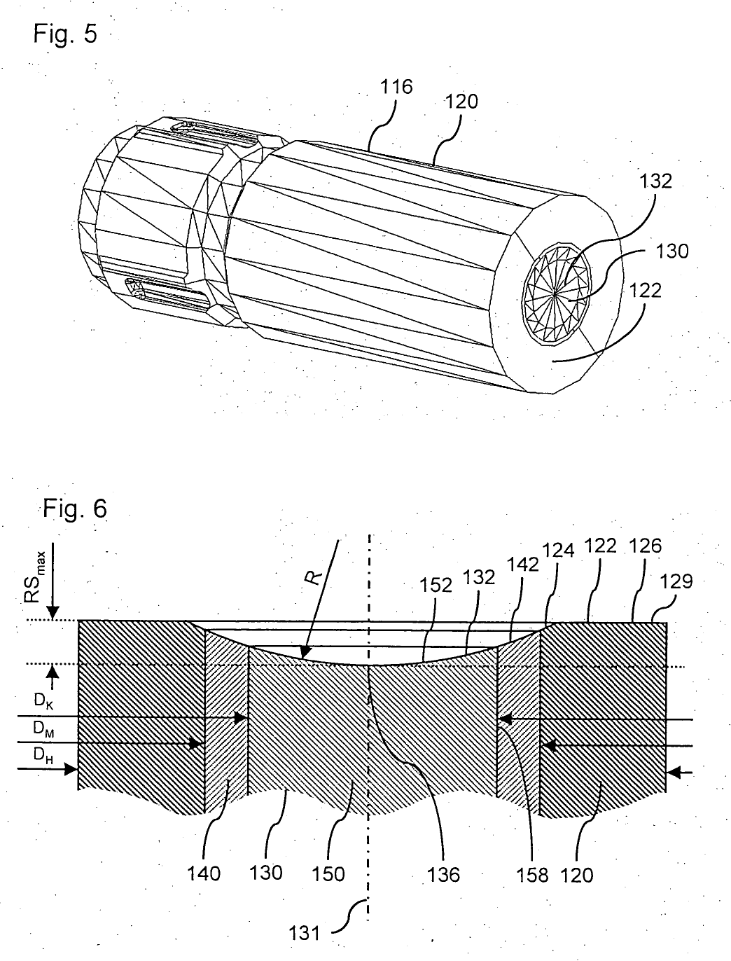

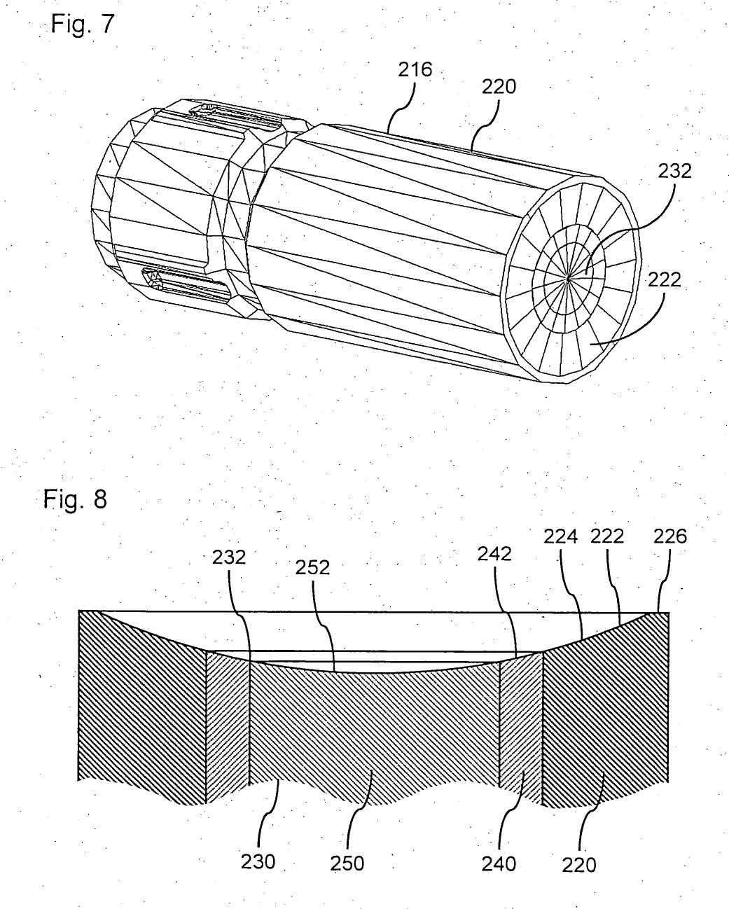

FIGS. 5 and 6 show a connection pin 116 with a front end face or connection face 132 of the waveguide section 130 that is milled away in a spherically concave form.

As can best be seen in FIG. 6, the front end faces 132 and 142 of the waveguide section 130 and of the jacket 140, respectively, are milled away in a completely concave form. The front end face 122 of the sleeve 120 has an inner, likewise concavely milled-away ring 124 and an outer, planar ring 126, the inner concave ring adjoining flush with the surface of the front end face 132 of the waveguide section 130.

In this case, only a small part of the sleeve 120 is milled away, so that the width of the outer ring 126 is greater than the width of the inner ring 124. In this example, the width of the inner ring 124 is approximately 50 μm. The front end face 132 of the waveguide section is formed or depressed rotationally symmetrically about the longitudinal axis 131.

The radius of curvature R of the spherically concave front surfaces 142 and 152 and also 132 and 124 is 8 mm. This radius has proven to be a good compromise for diameters of the sleeve of D_{H}=2.9 mm, of the jacket of D_{M}=1.5 mm and of the core of D_{K}=1 mm.

The milling depth or the maximum set-back RSₘₐₓ between the end face 122 of the sleeve 120 and the apex point 136 of the depression is 40 μm. The difference of the set-back between the apex point 136 and the outer edge 158 of the core 150 is 15.6 μm. This gives a minimum set-back of the core 150, that is at the outer edge 158 in relation to the surface 129 of the front end face 122, of 14.4 μm. Consequently, the set-back of the core 150 over its entire front end face 152 lies between 14.4 μm and 40 μm and is consequently within the MOST tolerance of 0 to 50 μm.

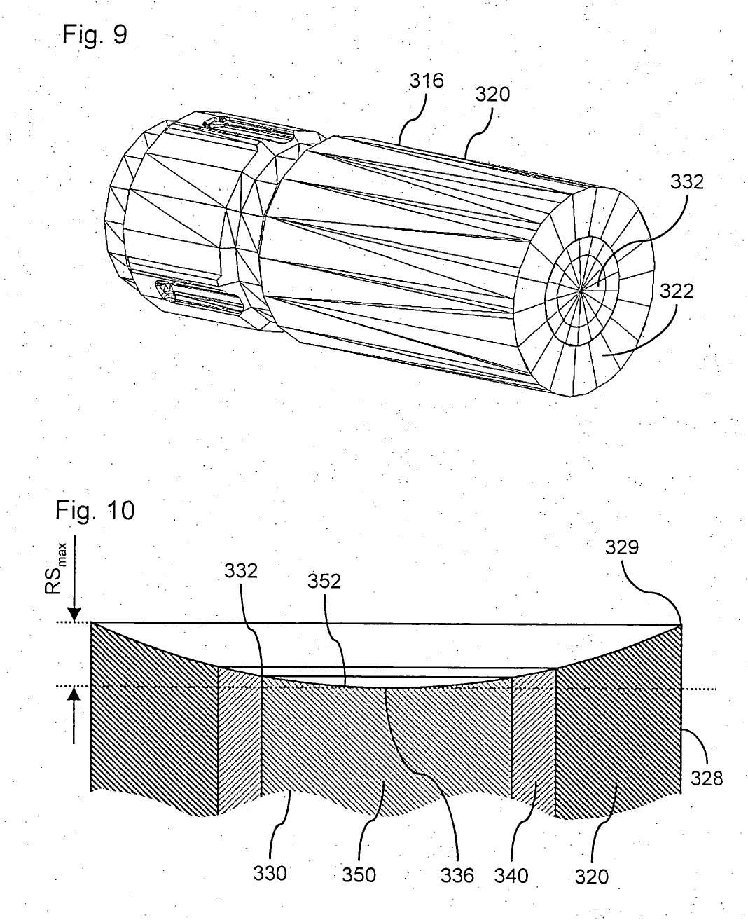

FIGS. 7 and 8 show a further exemplary embodiment of the invention, in which the sleeve 220 is milled away or out more than the sleeve 120. The inner, concave ring 224 is approximately 10 times as wide as the outer, planar ring 226 of the end face 222 of the sleeve 220. The front end faces 252 and 242 of the core 250 and of the jacket 240, respectively, i.e. the front end face 232 of the waveguide section 230, are formed in a completely spherically concave manner.

FIGS. 9 and 10 show a further exemplary embodiment, in which the front end face 322 of the sleeve 320 has been milled away completely over its entire diameter to its outer edge 328. In order to achieve a suitable set-back of the end face 332 of the waveguide section 330, or of the end face 352 of the core 350, a milling cutter with a radius of approximately 22 mm is used, whereby a set-back RSₘₐₓ of the apex point 336 in relation to the front edge 329 of the sleeve 320 of approximately 48 μm is created.

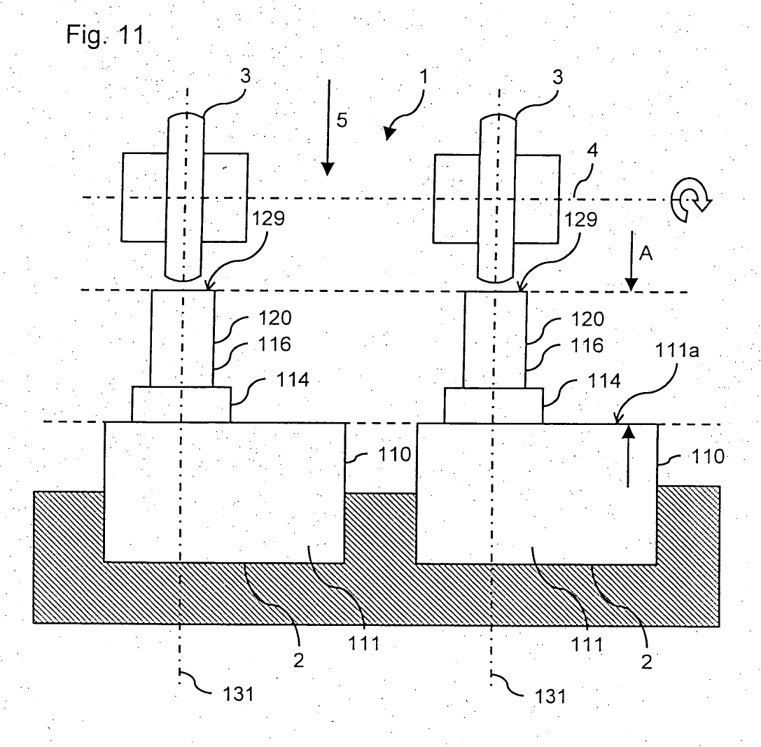

FIG. 11 shows an apparatus 1 according to the invention for the simultaneous milling away of two connection pins 116. The apparatus 1 comprises two receptacles 2, for temporarily fastening a component 110 in each case. Two milling cutters 3 rotate perpendicularly in relation to the longitudinal axes 131 of the connection pins 116 about an axis 4. For machining parallel to the longitudinal axes 131, the two milling cutters 3 are lowered in the direction of the arrow 5 onto the connection pins 116, until the predetermined set-back or a predetermined distance A of the front edge 129 of the sleeve 120 from a front side 111a of the component 110, to be more precise of the component housing 111, is achieved. It is clear that the concept can be extended from two components to more than two components or a multiplicity of components.

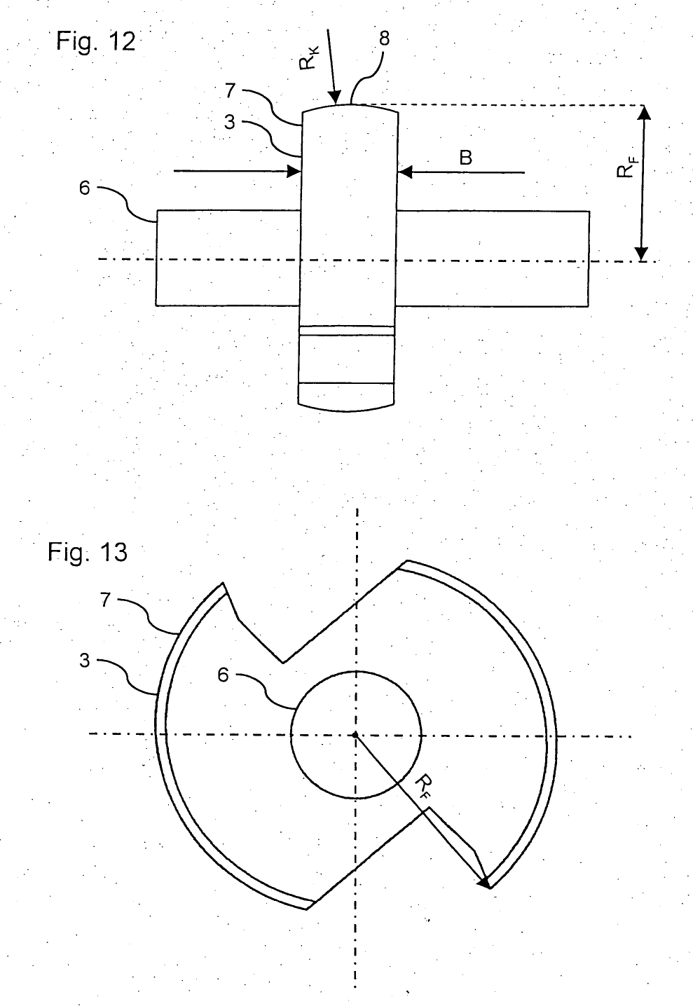

FIGS. 12 and 13 show in detail the milling cutter 3 with which the terminal pin 116 in FIGS. 5 and 6 is produced.

The milling cutter 3 has a cylindrical carrier 6 and a blade section 7 projecting from this carrier and having a blade width of B=1.6 mm. The surface 8 of the blade section 7 is diamond-impregnated. As a result, in the surface-removing operation the surface of the waveguide section is already machined with a finish suitable for permitting low-loss signal coupling in/out without additional polishing. For prototypes, a high-grade steel blade may also be used.

The radius R_{F} of the milling cutter is, for example, 8 mm, the blade surface 8 being spherical, i.e. the radius of curvature R_{K} of the blade surface is 8 mm in both dimensions.

It is evident to a person skilled in the art that the embodiments described above are to be understood as being given by way of example, and the invention is not restricted to these but can be varied in many ways without departing from the spirit and scope of the invention.

What is claimed is:

1. A method for producing an assembly having a waveguide section and an optical or optoelectronic component, the method comprising:
providing the waveguide section, which has a first and a second end face, the second end face lying opposite from the first end face, and providing a sleeve for enclosing the waveguide section;
providing the component, which has a receptacle for the waveguide section and the sleeve;
inserting the waveguide section with the first end face into the receptacle of the component, the sleeve surrounding the waveguide section at least partly,; and
cutting the waveguide section to length;
wherein the cutting-to-length of the waveguide section is carried out after the insertion of the waveguide section and the sleeve into the receptacle of the component.

2. The method as claimed in claim 1, wherein the cutting-to-length of the waveguide section is carried out by means of machining the second end face of the waveguide section.

3. The method as claimed in claim 1, wherein the machining of the second end face takes place by material removal, in particular by means of milling or grinding.

4. The method as claimed in claim 1, wherein a surface, which is suitable for coupling optical signals in or out, is created on the second end face of the waveguide section, and wherein the creation of the surface and the cutting-to-length takes place in the same working step.

5. The method as claimed in claim 1, wherein the waveguide section is mounted on the component when the waveguide section is cut to length, and the waveguide section is shortened by means of the cutting-to-length until a predetermined set-back of the second end face of the waveguide section is created in relation to an end face of the sleeve enclosing the second end face of the waveguide section.

6. The method as claimed in claim 1, wherein the waveguide section is already mounted on the component when it is cut to length, and the sleeve is shortened by means of the cutting-to-length until a predetermined distance of a front edge of the sleeve from the component is created.

7. The method as claimed in claim 5, wherein the maximum of the set-back from a front edge of the sleeve is between about 0 μm and about 500 μm.

8. The method as claimed in claim 1, wherein a second end face of the sleeve, which encloses the second end face of the waveguide section, is machined at a point in time at which the waveguide section and the sleeve are fastened on the component, in one working step with the second end face of the waveguide section.

9. The method as claimed in claim 1, wherein the second end face of the waveguide section is provided with a concave surface.

10. The method as claimed in claim 1, wherein the second end face of the waveguide section is provided with a spherical surface with a radius of curvature of about 2 mm to about 100 mm.

11. The method as claimed in claim 1, wherein the second end face of the waveguide section is machined with a milling cutter or grinding cutter with a diameter (R_{F}) of about 4 mm to 100 mm and a blade width of about 1 mm to about 50 mm.

12. The method as claimed in claim 1, wherein thee waveguide section is made of plastic with a core diameter (D_{X}) of approximately 1 mm is used.

13. An assembly comprising:
an optical component; and
a connection pin having a waveguide section and a sleeve, the waveguide section being enclosed in the sleeve and arranged with a first end face on the component in such a way that optical signals are coupled into the component from the waveguide section or coupled out of the component into the waveguide section, the connection pin being fastened on the component, the waveguide section having a second end face lying opposite from the first end face by which optical signals are coupled in or out, the second end face of the waveguide section having a concave form.

14. The assembly as claimed in claim 13, wherein the concave second end face of the waveguide section has a radius of curvature (R) of about 2 to about 100 mm.

15. The assembly as claimed in claim 13, wherein the second end face of the waveguide section is formed in a two-dimensionally concave manner.

16. The assembly as claimed in claim 13, wherein the second end face of the waveguide section has a spherical depression.

17. The assembly as claimed in claim 13, wherein the sleeve has a front end face, which surrounds the second end face of the waveguide section, and the front end face of the sleeve is formed at least partly in a concave manner and/or adjoins flush with the surface of the second end face of the waveguide section.

18. The assembly as claimed in claim 13, wherein the optical component comprises a housing and the sleeve is formed integrally with the housing.

19. An apparatus, set up for machining a waveguide section that is fastened in a sleeve on an optical component, the apparatus comprising:
a receptacle for the optical component;
a front end face of the waveguide section being remote from the component and being accessible when the component is arranged in the receptacle;
a milling cutter or grinding cutter that rotates transversely in relation to a longitudinal axis of the waveguide section and is capable of being displaced parallel to the waveguide section when the component is arranged in the receptacle, and is set up for removing material from the front end face of the waveguide section; and
the apparatus having a control device being an automatic control program, the control program capable of aligning the milling cutter or grinding cutter and the waveguide section in a centered manner in relation to each other and controlling subsequently removal of material from the front end face of the waveguide section with the milling cutter or grinding cutter in such a way that material removal is continued until a predefined distance (RS) between the surface of the end face of the waveguide section and the component is reached or a predetermined distance between a front edge of the sleeve and the component is reached.
